(19) United States
(12) Patent Application Publication
(10) Pub. No.: US 2010/0115018 A1
(43) Pub. Date: May 6, 2010

(54) INTERCEPTION METHOD INTERWORKING WITH COMMUNICATION NETWORK AND INTERNET NETWORK

(75) Inventors: Byungsik YOON, Daejeon (KR); Song In CHOI, Daejeon (KR); Jee Hwan AHN, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/540,088

(22) Filed: Aug. 12, 2009

(30) Foreign Application Priority Data
Oct. 31, 2008 (KR) 10-2008-0108072

(51) Int. Cl. G06F 15/16

(52) U.S. Cl. 709/201

(57) ABSTRACT

Disclosed is an interception method that interworks with a communication network and an Internet network. A law enforcement agency system verifies whether an interception target presently uses an Internet service by using a terminal other than a terminal registered as the interception target on the basis of Internet service access information of the interception target. When the interception target uses the Internet service by using the other terminal, the law enforcement agency system updates interception target information on the basis of IP address information of the corresponding terminal, which is included in the Internet service access information and transmits the updated interception target information to a communication service provider.

### CROSS-REFERENCE TO RELATED APPLICATION

This application claims priority to and the benefit of Korean Patent Application No. 10-2008-0108072 filed in the Korean Intellectual Property Office on Oct. 31, 2008, the entire contents of which are incorporated herein by reference.

### BACKGROUND OF THE INVENTION

(a) Field of the Invention

The present invention relates to an interception method that interworks with a communication network and an Internet network.

(b) Description of the Related Art

As a communication system has rapidly developed, efficient interception cannot be achieved by a wire tapping method. Therefore, communication-advanced countries such as U.S.A., Europe, etc. have a lawful interception scheme to be suitable for a communication system which has rapidly developed. Further, law enforcement agencies and telecommunication/service providers have standardized a lawful interception procedure on a law of each country concerning the interception.

In general, in the lawful communication interception scheme, a lawful interception agency is served with a lawful interception warrant on a predetermined user from a court and informs the telecommunication provider. Therefore, the telecommunication provider directs a mediation device to perform the interception through administration of lawful interception (hereinafter, referred to as ‘LI’). Herein, the mediation device assigns an interception target to an intercepting control element (hereinafter, referred to as ‘ICE’) that takes charge of authentication of a subscriber or charging and collects various intercept related information (hereinafter, referred to as ‘IRI’). The IRI includes charging information of the interception target, call processing information, IP address information, telephone number information, calling list information, etc. The mediation device formats the collected IRI to be suitable for a predetermined agreed interface and transmits the formatted IRI to the lawful interception agency in the format of a communication identifying information (hereinafter, referred to as ‘CmII’). In the case when a calling list or interception of presently transmitted communication contents are needed, the mediation device requests actual interception of communication contents to the intercepting network element (hereinafter, referred to as ‘INE’) that takes charge of actual transmission of the communication contents. Therefore, when the interception target performs communication, the ICE that recognizes it transmits communication information of the interception target to the INE and the INE transmits communication contents copying a calling list of the interception target from the received communication information of the interception target to the mediation device. The mediation device formats the relevant communication contents to be suitable for the predetermined agreed interface and transmits the formatted communication contents to the lawful interception agency in the format of the communication contents (hereinafter, referred to as ‘CC’).

Meanwhile, in the case of the above-mentioned lawful communication interception scheme, as an interception method when the ICE accurately recognizes the interception target, when the interception target accesses a communication system by using terminals of other users (in the case of a terminal authentication scheme) or plagiarizing IDs of other users (in the case of a user authentication scheme) at the time of accessing the communication system, the ICE cannot recognize that the interception target accesses the communication system. Therefore, interception of the corresponding interception target cannot be made. That is, actually, the interception target that needs to be intercepted can easily avoid the interception when accessing the communication system by using other terminals or IDs of other users.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide an interception method having advantages of solving interception avoidance of an interception target.

An exemplary embodiment of the present invention provides an interception method in which a law enforcement agency system performs interception of an interception target with interworking with a communication service system and an Internet service system connected through a network, includes transmitting interception target information corresponding to the interception target to the Internet service system and the communication service system; receiving Internet service access information collected on the basis of the interception target information from the Internet service system; verifying a terminal which the interception target uses for using an Internet service on the basis of the Internet service access information; and updating the interception target information to include information of the terminal in use and transmitting the updated interception target information to the communication service system.

Another embodiment of the present invention provides in which a communication service system performs interception of an interception target with interworking with a law enforcement agency system connected through a network, includes receiving interception target information including terminal information of the interception target from the law enforcement agency system; when the interception target uses an Internet service by using a terminal other than a terminal corresponding to the terminal information, receiving interception target information updated to include information corresponding to the other terminal from the law enforcement agency system; and transmitting interception information collected on the basis of the updated interception target information to the law enforcement agency system.

According to the present invention, it is possible to effectively solve interception avoidance of an interception target.

### BRIEF DESCRIPTION OF THE DRAWINGS

FIG. 1 is a configuration diagram illustrating an interception system according to an exemplary embodiment of the present invention.

FIG. 2 is a flowchart illustrating an interception method according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, in addition, unless explicitly described to the contrary, the word “comprise” and variations such as “comprises” or “comprising”, will be understood to imply the inclusion of stated elements but not the exclusion of any other elements

Hereinafter, an interception method according to an exemplary embodiment will be described in detail with reference to the accompanying drawings.

Hereinafter, a person who becomes a target of lawful interception is referred to as ‘interception target’ and a system of an agency that acquires a lawful interception authority for the interception target is referred to as ‘law enforcement agency system’. Further, a provider system that provides a packet-based communication service to a user is referred to as ‘communication service system’ and a provider system that provides an Internet service is referred to as ‘Internet service system’.

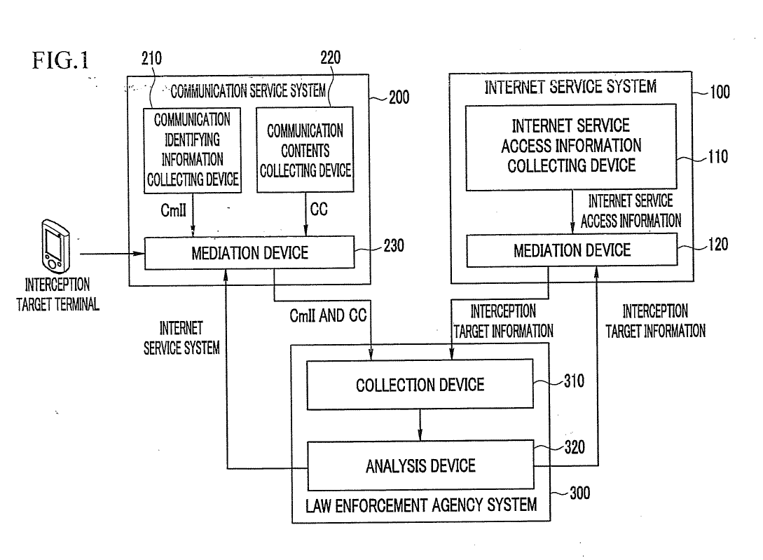

FIG. 1 is a configuration diagram illustrating an interception system according to an exemplary embodiment of the present invention.

Referring to FIG. 1, an interception system includes an Internet service system 100, a communication service system 200, and a law enforcement agency system 300.

The Internet service system 100 includes an Internet service access information collecting device 110 and a mediation device 120. The internet service system 100 receives Internet service access information of an interception target on the basis of interception target information received from the law enforcement agency system 300 connected through a network and transmits the Internet service access information to the law enforcement agency system 300. Herein, the interception target information includes at least one of personal information, terminal information, and Internet service account information of the interception targets. The internet service account information includes account information which the interception target uses for using an Internet service, that is, e-mail, file transfer protocol (FTP) ID information, etc.

The Internet service access information collecting device 110 recognizes an Internet service use timing of the interception target by using the interception target information transmitted from the law enforcement agency system 300 and collects the Internet service access information including at least one of IP address information which the interception target uses for using the Internet service, an Internet service list of the interception target, and Internet service contents. Herein, the Internet service access information collecting device 110 recognizes a time when an interception target terminal accesses the Internet service system 100 for using the Internet service or the Internet service is used by using ID corresponding to the Internet service account information of the interception target as the Internet service use timing of the interception target.

The mediation device 120 formats and transmits the Internet service access information collected in the Internet service access information collecting device 110 in the format previously agreed with the law enforcement agency system 300 to the law enforcement agency system 300.

The communication service system 200 includes a communication identifying information (CmII) collecting device 210, a communication contents (CC) collecting device 220, and a mediation device 230. The communication service system 200 collects communication identifying information (CmII) of the interception target and the communication contents (CC) on the basis of the interception information transmitted from the law enforcement agency system 300.

The communication identifying information collecting device 210 is located in remote authentication dial-in user services (RADIUS)/dynamic host configuration protocol (DHCP) server, etc. and recognizes a communication occurrence timing of the interception target by using the interception target information transmitted from the law enforcement agency system 300. In addition, the communication identifying information collecting device 210 collects communication identifying information (CmII) that corresponds to the communication service access contents of the interception target from the communication occurrence timing. Herein, the communication identifying information may include communication partner information, charging information, positional information of the interception target, etc.

The communication contents collecting device 220 is located in a router, etc. and recognizes the communication occurrence timing of the interception target by using the interception target information transmitted from the law enforcement agency system 300 like the communication identifying information collecting device 210. In addition, the communication contents collecting device 220 collects the communication contents (CC) corresponding to the calling list of the interception target from the communication occurrence timing.

The mediation device 230 formats the communication identifying information (CmII) and the communication contents (CC) collected through the communication identifying information (CmII) collecting device 210 and the communication contents (CC) collecting device 220 in the format previously agreed with the law enforcement agency system 300 and transmits the communication identifying information (CmII) and the communication contents (CC) to the law enforcement agency system 300.

The law enforcement agency system 300 includes a collection device 310 and an analysis device 320. The law enforcement agency system 300 transmits the interception target information to the communication service system 200 and the Internet service system 100 and analyzes the interception information including the CmII, the CC, the Internet service access information, etc. received from the communication service system 200 and the Internet service system 100 to perform interception of the interception target. Herein, when a law enforcement agency requests the interception of the interception target through a lawful procedure and an authorization agency that authorizes the interception request issues a warrant on the interception target, the law enforcement agency system 300 transmits the warrant to the communication service system 200 and the Internet service system 100.

The collection device 310 collects the interception information including the CmII, the CC, the Internet service access information, etc. from the communication service system 200 and the Internet service system 100.

The analysis device 320 analyzes and uses the collected interception information for the interception of the interception target.

Meanwhile, since the interception target can use the Internet service through terminals of other users or terminals installed in public spaces, not the terminal registered as the interception target, interception avoidance of the interception target cannot be prevented only by collecting the Internet service access information of the registered interception target's terminal. Therefore, the analysis device 320 analyzes the Internet service access information of the interception target, which is collected through the Internet service system 100 and checks whether the interception target uses the Internet service by using not the terminal registered as the interception target but other terminals. For example, the analysis device 320 checks IP address information included in the Internet service access information and verifies whether a terminal used by the interception target is registered as the interception target.

From the verification result, when the interception target uses the Internet service by using a terminal other than the terminal registered as the interception target, the analysis device 320 updates and transmits the interception target information to the Internet service system 100 and the communication service system 200. Herein, the analysis device 320 transmits the interception target information including at least one of IP address information corresponding to a terminal which the interception target presently uses, user's personal information, and terminal information at the time of updating and transmitting the interception target information to the communication service system 200. Meanwhile, the Internet service system 100 and the communication service system 200 that receive the updated interception target information collects and transmits the interception information to the law enforcement agency system 300 on the basis of the updated interception target information.

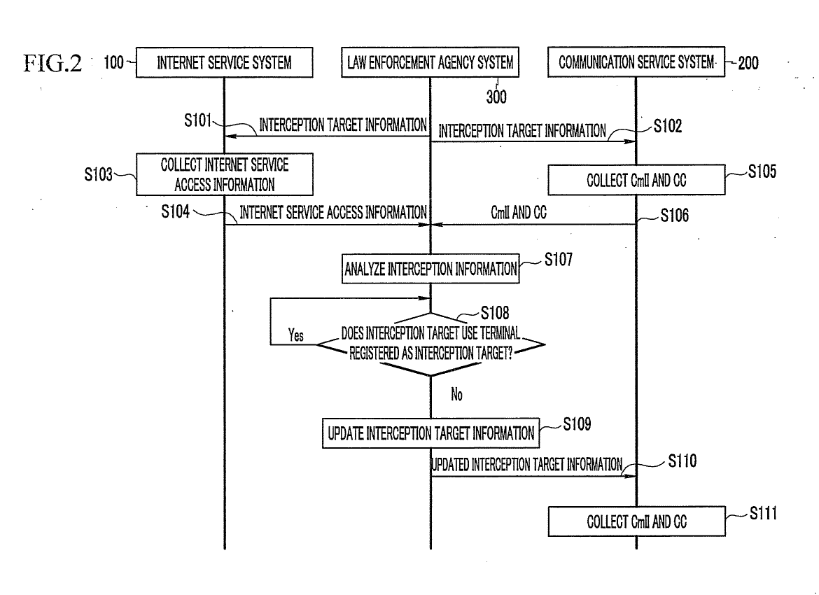

FIG. 2 is a flowchart illustrating an interception method according to an exemplary embodiment of the present invention.

Referring to FIG. 2, when the warrant on the interception target is issued through a lawful process, the law enforcement agency system 300 transmits the interception target information including at least one of the personal information, the terminal information, and the Internet service account information of the interception target to the Internet service system 100 and the communication service system 200 (S101 and S102).

The Internet service system 100 that receives the interception target information collects and transmits the Internet service access information of the interception target to the law enforcement agency system 300 on the basis of the interception target information (S103 and S104). The communication service system 200 collects and transmits the communication identifying information (CmII) and the communication contents (CC) of the interception target to the law enforcement agency system 300 on the basis of the interception target information (S105 and S106).

The law enforcement agency system 300 that receives the interception information including the internet service access information, the CmII, the CC, etc. from the internet service system 100 and the communication service system 200 analyzes the received interception information (S107). In particular, the law enforcement agency system 300 analyzes the Internet service access information received from the Internet service system 100 and verifies whether the interception target uses the Internet service by using the terminal registered as the interception target. (S108). Herein, the law enforcement agency system 300 may use the IP address information included in the Internet service access information in order to verify whether or not the terminal used by the interception target is the terminal registered as the interception target.

From the verification result, when the interception target uses the Internet service by using a terminal other than the terminal registered as the interception target, the law enforcement agency system 300 updates the interception target information including at least one of the IP address information which the interception target uses, the user's personal information corresponding to the relevant IP address information, and the terminal information (S109). The law enforcement agency system 300 transmits the updated interception target information to the communication service system 200 (S110). As a result, the communication service system 200 collects and transmits the communication identifying information (CmII) and the communication contents (CC) that correspond to the interception target to the law enforcement agency system 300 on the basis of the updated interception target information (S110 and S111). That is, the communication service system 200 collects and transmits communication identifying information (CmII) and communication contents (CC) for a communication service using a terminal corresponding to IP address information, personal information, and terminal information that are newly added to the interception target information to the law enforcement agency system 300.

As described above, a law enforcement agency system 300 can verify a terminal used by an interception target on the basis of Internet service access information of the interception target, such that even though the interception target uses an Internet service or a communication service by using a terminal other than a terminal registered as an interception target's own name, the interception target can be easily chased, thereby preventing interception avoidance of the interception target.

Meanwhile, in an exemplary embodiment of the present invention, a case of updating interception target information is described as one example when an interception target uses an Internet service by using a terminal other than a terminal registered as the interception target, but the exemplary embodiment of the present invention is not limited to the case and may be applied to a case in which the interception target uses the Internet service by using a terminal other than a terminal corresponding to an interception target terminal information included in the interception target information. In this case, even thought the interception target uses the communication service by using a terminal through changing a communication service provider, the changed terminal can be chased on the basis of Internet service information using the corresponding terminal, thereby preventing the interception avoidance of the interception target.

The exemplary embodiments of the present invention are implemented through only the apparatus and method, but may be implemented through a program that realizes functions corresponding to constituent members of the exemplary embodiments of the present invention or a recording medium in which the program is recorded. The implementation will be easily implemented by those skilled in the art as described in the exemplary embodiments.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An interception method in which a law enforcement agency system performs interception of an interception target with interworking with a communication service system and an Internet service system connected through a network, comprising
transmitting interception target information corresponding to the interception target to the Internet service system and the communication service system;
receiving Internet service access information collected on the basis of the interception target information from the Internet service system;
verifying a terminal which the interception target uses for using an Internet service on the basis of the Internet service access information; and
updating the interception target information to include information of the terminal in use and transmitting the updated interception target information to the communication service system.

2. The interception method of claim 1, wherein:
the transmitting the uadated interception target information includes:
when the interception target uses the Internet service by using a terminal other than a terminal registered as the interception target, updating the interception target information to include at least one of IP address information corresponding to the other terminal, user's personal information, and terminal information; and
transmitting the updated interception target information to the communication service system.

3. The interception method of claim 2, wherein:
the verifying the terminal verifies the terminal used for the Internet service on the basis of the IP address information included in the Internet service access information.

4. The interception method of claim 2, further comprising:
receiving communication verifying information and communication contents that are collected on the basis of the updated interception target information from the communication service system.

5. The interception method of claim 3, wherein:
the Internet service access information includes at least one of IP address information which the interception target uses for the Internet service, Internet service list of the interception target, and Internet service contents.

6. An interception method in which a communication service system performs interception of an interception target with interworking with a law enforcement agency system connected through a network, comprising:
receiving interception target information including terminal information of the interception target from the law enforcement agency system;
when the interception target uses an Internet service by using a terminal other than a terminal corresponding to the terminal information, receiving interception target information updated to include information corresponding to the other terminal from the law enforcement agency system; and
transmitting interception information collected on the basis of the updated interception target information to the law enforcement agency system.

7. The interception method of claim 6, wherein:
the law enforcement agency system receives Internet service access information collected on the basis of the interception target information from an Internet service system connected through the network and verifies a terminal which the interception target uses on the basis of the Internet service access information.

8. The interception method of claim 7, wherein:
the law enforcement agency system updates the interception target information on the basis of IP address information included in the Internet service access information when the interception target uses the Internet service by using the other terminal.

9. The interception method of claim 6, wherein:
the interception information includes communication identifying information and communication contents.
